(19) United States
(12) Patent Application Publication
(10) Pub. No.: US 2007/0171802 A1
(43) Pub. Date: Jul. 26, 2007

(54) Optical disc apparatus and method for adjusting the same

(75) Inventors: Tsuyoshi Eiza, Osaka (JP); Shinya Shimizu, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/655,889

(22) Filed: Jan. 22, 2007

(30) Foreign Application Priority Data
Jan. 25, 2006 (JP) 2006-015984

(51) Int. Cl. G11B 7/00

(52) U.S. Cl. 369/112.02; 369/53.2

(57) ABSTRACT

An adjusting method includes a preparing step for obtaining an applied voltage value and a phase difference in a liquid crystal element in the case where an optimal reproduced signal is obtained for each of a plurality of types of optical recording media by using a reference optical disc apparatus, and for generating and storing predetermined reference data, and an adjusting step for obtaining a voltage value for adjusting characteristic variation of liquid crystal for all the plurality of types of optical recording media by obtaining a first voltage value to be applied to the liquid crystal element in the case where an optimal reproduced signal is obtained for the optical disc apparatus to be adjusted when one type of optical recording medium is regarded as an adjustment optical recording medium among the plurality of types of optical recording media, and by calculating a second voltage value to be applied to the liquid crystal element in which characteristic variation of the liquid crystal is adjusted from the reference data and the first voltage value for each of the plurality of types of optical recording media except the adjustment optical recording medium.

This application is based on Japanese Patent Application No. 2006-015984 filed on Jan. 25, 2006, the content of which is hereby incorporated by reference.

### BACKGROUND OF THE INVENTION

1. Field of the Invention

The present invention relates to a method for adjusting an optical disc apparatus that performs reading and writing or performs only reading of optical recording media. In particular, the present invention relates to a method for adjusting characteristic variation in liquid crystal among optical pick up devices of an optical disc apparatus equipped with a liquid crystal element. In addition, the present invention relates to an optical disc apparatus equipped with a liquid crystal element having adjusted characteristic variation among devices in the liquid crystal.

2. Description of Related Art

Optical recording media including a compact disc (hereinafter referred to as CD) and a digital versatile disc (hereinafter referred to as DVD) are widely available. Furthermore, in recent years, studies about high density recording on the optical recording medium have been proceeding in order to increase recording capacity of the optical recording medium. For example, high density optical recording media including an HD-DVD and a Blu-Ray Disc (hereinafter referred to as BD) that are high quality DVDs, are being available.

The optical recording medium is read or written by an optical disc apparatus, which is realized by using an optical pickup device that enables reading and writing information on the optical recording medium by projecting a light beam to the optical recording medium. Recently, a plurality of types of optical recording media are available as described above, and many optical pickup devices that can read and write information on the plurality of types of optical recording media by a single device, are being developed.

When the type of the optical recording medium is different, thickness of a protection layer that protects a recording surface of the optical recording medium can be different. For example, thickness values of the protection layers for a CD, a DVD, and a BD are 1.2 mm, 0.6 mm, and 0.1 mm, respectively. As to an optical pickup device that supports a plurality of types of optical recording media having different thickness values of the protection layer as described above, there is a case where a single objective lens is used for condensing light beams from light sources onto the recording surface of the optical recording medium. In this case, even if the objective lens is adjusted so that spherical aberration is not generated for one type of the optical recording medium, the spherical aberration can be generated when information is read or written on the other type of the optical recording medium. Therefore, it is common to adopt a structure in which a liquid crystal element is disposed in the optical pickup device, and voltage to be applied to the liquid crystal element is controlled. Thus, a phase of the light beam that passes through the liquid crystal element is controlled so that the spherical aberration is corrected.

However, in the case where the liquid crystal element is disposed in the optical pickup device as above described, because there is characteristic variation of the liquid crystal in many cases, when the voltage to be applied to the liquid crystal element is set to be the same value for every optical disc apparatus, a reproduced signal may generate variation that causes deterioration in quality of reproduced signal of the optical disc apparatus.

As to this point, it is possible to create data concerning optimal voltage values to be applied to the liquid crystal element for each of the optical disc apparatus in advance and to make the optical disc apparatus store the data in advance when the optical disc apparatus is manufactured or after it is manufactured, considering that there is characteristic variation of the liquid crystal. However, it is the recent mainstream that the optical disc apparatus should support a plurality of types of optical recording media. In this case, it is necessary to create data of voltages to be applied to the liquid crystal element for each of the optical recording media. This work of adjustment may require a lot of time.

In addition, a reproducing method with stable quality without being affected by the characteristic variation of the liquid crystal is disclosed in JP-A-2004-185758 or JP-A-2005-011468. According to the method, when information is reproduced and the like on an optical recording medium by using the optical disc apparatus, jitter is measured, or the same structure as measuring the jitter actually is formed in the optical disc drive. In accordance with its result, the voltages that are applied to the liquid crystal element are adjusted in turn so that the resulted jitter becomes close to the optimal value. In this structure, however, a control mechanism of the optical disc apparatus becomes complicated so that the number of components on an integrated circuit and a chip size of the integrated circuit may increase. In this case, a size and manufacturing cost of the optical disc apparatus may be increased.

### SUMMARY OF THE INVENTION

In view of the above described problems, it is an object of the present invention to provide a method of fast adjustment of characteristic variation among devices in the liquid crystal of the optical disc apparatus equipped with a liquid crystal element for supporting a plurality of types of the optical recording media. In addition, it is another object of the present invention to provide an optical disc apparatus that can suppress characteristic variation among devices in the liquid crystal for an optical disc apparatus equipped with a liquid crystal element for supporting a plurality of types of optical recording media.

To attain the above described object, as to a first aspect of the present invention, an adjusting method of an optical disc apparatus for adjusting characteristic variation in liquid crystal among optical pick up devices is provided. The optical disc apparatus can perform reading and writing or perform only reading of a plurality of types of optical recording media and is equipped with a liquid crystal element disposed in an optical system of an optical pickup, the liquid crystal element including liquid crystal and two transparent electrodes sandwiching the liquid crystal. The method includes a preparing step for performing a measurement by using an optical pickup having the same optical system as the optical pickup of the optical disc apparatus to be adjusted so as to obtain a reference voltage value that is a voltage value to be applied to the transparent electrode in the case where an optimal reproduced signal is obtained for each of the plurality of types of optical recording media and a reference phase difference that is a phase difference generated in the liquid crystal element when the reference voltage value is applied, and for creating and storing predetermined data concerning the reference voltage value and the reference phase difference as reference data, and an adjusting step for obtaining an adjustment voltage value for adjusting characteristic variation of the liquid crystal for all the plurality of types of optical recording media by selecting one type of optical recording medium among the plurality of types of optical recording media as an adjustment optical recording medium, by obtaining a first voltage value that is applied to the transparent electrode in the case where the optimal reproduced signal is obtained for the optical disc apparatus to be adjusted by using a predetermined optical recording medium for the adjustment optical recording medium, and by calculating a second voltage value to be applied to the transparent electrode in which characteristic variation of the liquid crystal is adjusted from the reference data and the first voltage value for each of the plurality of types of optical recording media except the adjustment optical recording medium.

As to a second aspect of the present invention, in the adjusting method of an optical disc apparatus as described above, at least one of the transparent electrodes is divided into a plurality of concentric areas, and the adjusting step includes a first step for obtaining the first voltage value to be applied to each of the areas for the optical disc apparatus to be adjusted by using the predetermined optical recording medium, a second step for calculating characteristic of the liquid crystal that is determined as a ratio of a difference between the first voltage values in two predetermined areas to a difference between reference phase differences in the two predetermined areas among the first voltage values of the areas obtained in the first step, a third step for calculating the second voltage value for each of the plurality of types of optical recording media except the adjustment optical recording medium by using the characteristic of the liquid crystal obtained in the second step and the reference data, and a fourth step for storing the first and the second voltage values obtained in the first and the third steps as the adjustment voltage value in a storage portion provided to the inside of the optical disc apparatus to be adjusted.

As to a third aspect of the present invention, in the adjusting method of an optical disc apparatus as described above, the two predetermined areas includes an area in which the first voltage value becomes a maximum value and an area in which the first voltage value becomes a minimum value.

As to a fourth aspect of the present invention, an adjusting method of an optical disc apparatus for adjusting characteristic variation in liquid crystal among optical pick up devices is provided. The optical disc apparatus can perform reading and writing or perform only reading of a plurality of types of optical recording media and is equipped with a liquid crystal element disposed in an optical system of an optical pickup, the liquid crystal element including liquid crystal and two transparent electrodes sandwiching the liquid crystal, at least one of the transparent electrodes being divided into a plurality of concentric areas. The method includes a preparing step for performing a measurement by using an optical pickup having the same optical system as the optical pickup of the optical disc apparatus to be adjusted so as to obtain a reference voltage value that is a voltage value to be applied to each of the areas of the transparent electrode in the case where an optimal reproduced signal is obtained for each of the plurality of types of optical recording media and a reference phase difference that is a phase difference generated in each of the areas when the reference voltage value is applied, and for creating and storing predetermined data concerning the reference voltage value and the reference phase difference as reference data, and an adjusting step including a first step for selecting one type of optical recording medium among the plurality of types of optical recording media as an adjustment optical recording medium, and for obtaining a first voltage value to be applied to each of the areas in the case where an optimal reproduced signal is obtained for the optical disc apparatus to be adjusted by using the predetermined optical recording medium for the adjustment optical recording medium, a second step for calculating characteristic of the liquid crystal that is determined as a ratio of a difference between a maximum value and a minimum value of the first voltage value to a difference between the reference phase differences in the area where the first voltage becomes a maximum value and the area where the first voltage becomes a minimum value, a third step for calculating a second voltage value to be applied to the transparent electrode in which characteristic variation of the liquid crystal is adjusted for each of the plurality of types of optical recording media except the adjustment optical recording medium by using characteristic of the liquid crystal obtained in the second step and the reference data, and a fourth step for storing the first and the second voltage values obtained in the first and the third steps as the adjustment voltage value for adjusting characteristic variation of the liquid crystal in a storage portion provided to the inside of the optical disc apparatus to be adjusted.

Further, as to a fifth aspect of the present invention, an optical disc apparatus that is adjusted by the adjusting method of an optical disc apparatus described above is provided.

According to the first aspect of the present invention, when characteristic variation in liquid crystal among optical pick up devices of the optical disc apparatus is adjusted, the reference data are created once. Then, among the optical recording media that are capable of reading and writing or only reading by the optical disc apparatus, if the measurement is performed for any one type of optical recording medium so as to obtain the adjustment value, the adjustment values for other types of optical recording media can be obtained by calculation without real measurement. Therefore, characteristic variation in liquid crystal among optical pick up devices can be adjusted in a short time. In addition, when characteristic variation of the liquid crystal in the optical disc apparatus is adjusted, a correct adjustment voltage value can be obtained easily.

Further, according to the second aspect of the present invention, when characteristic variation in liquid crystal among optical pick up devices of the optical disc apparatus is adjusted, the reference data are created once. Then, among the optical recording media that are capable of reading and writing or only reading by the optical disc apparatus, if the measurement is performed for any one type of optical recording medium so as to obtain the adjustment value, the adjustment values for other types of optical recording media can be obtained by calculation without real measurement. Therefore, characteristic variation in liquid crystal among optical pick up devices can be adjusted in a short time. In addition, when characteristic variation of the liquid crystal in the optical disc apparatus is adjusted, a correct adjustment voltage value can be obtained easily.

Furthermore, according to the third aspect of the present invention, as to the adjusting method of an optical disc apparatus as described above, it is possible to realize a method for adjusting in a short time the characteristic variation of liquid crystal among devices of the optical disc apparatus that can read and write or only read a plurality of types of optical recording media.

Furthermore, according to the fourth aspect of the present invention, in the adjusting method of an optical disc apparatus as described above as the third aspect, it is possible to obtain an accurate adjustment value for adjusting characteristic variation of liquid crystal among devices.

Furthermore, according to the fifth aspect of the present invention, the optical disc apparatus is equipped with a liquid crystal element, and characteristic variation of liquid crystal of the liquid crystal element among devices is adjusted. Therefore, high quality of reproduction can be maintained easily. In addition, since undesired aberration is not generated due to the characteristic variation of the liquid crystal, it is possible to manufacture the optical disc apparatus without fine adjustment of voltages to be applied to the liquid crystal element during a period for reading and writing the optical recording medium. Thus, it is expected to manufacture a simple optical disc apparatus at low cost.

### BRIEF DESCRIPTION OF THE DRAWINGS

FIG. 1 is a block diagram to show a structure of an optical disc apparatus according to one embodiment of the present invention.

FIG. 2 is a schematic diagram of an optical system of an optical pickup device included in the optical disc apparatus according to the present embodiment.

FIGS. 3A and 3B are explanatory diagrams for explaining a structure of a liquid crystal element included in the optical pickup device; FIG. 3A is a cross sectional view, and FIG. 3B is a plan view.

FIG. 4 is a graph to show the spherical aberration and a pattern of a phase difference to be generated by the liquid crystal element for correcting the same.

FIGS. 5A and 5B are explanatory diagrams for explaining a concept of adjusting characteristic variation of the liquid crystal among devices according to the present invention; FIG. 5A is a graph concerning a reference optical disc apparatus, and

FIG. 5B is a graph concerning an optical disc apparatus to be adjusted.

FIG. 6 is a diagram to show a procedure of adjusting method of the optical disc apparatus for adjusting characteristic variation of liquid crystal.

### DESCRIPTION OF THE PREFERRED EMBODIMENTS

Now an embodiment of the present invention will be described in detail. It should be noted that that the embodiment described here is merely an example, and the present invention is not limited to this embodiment.

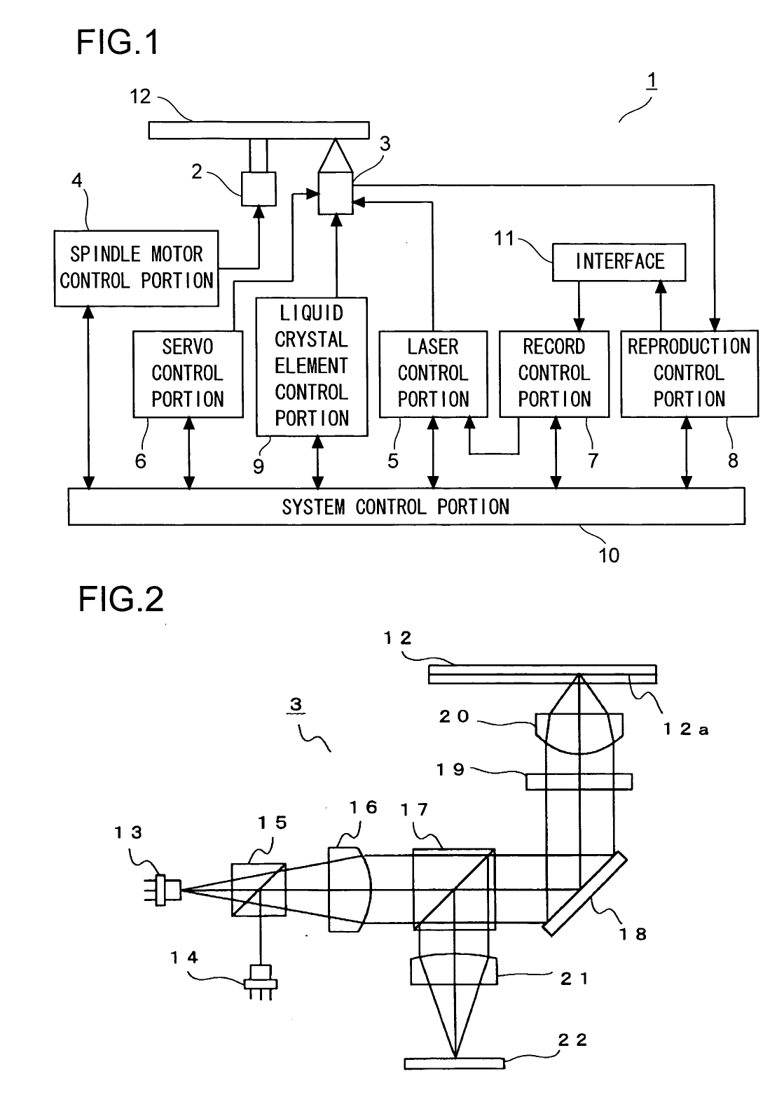

FIG. 1 is a block diagram to show a structure of an optical disc apparatus according to one embodiment of the present invention. The optical disc apparatus 1 can reproduce information from an optical recording medium 12 and record information on the optical recording medium 12. Numeral 2 denotes a spindle motor, and the optical recording medium 12 is retained detachably by a chucking portion (not shown) that is provided to the upper portion of the spindle motor 2. When information is recorded or reproduced on the optical recording medium 12, the spindle motor 2 rotates the optical recording medium 12 continuously. A control of rotation of the spindle motor 2 is performed by a spindle motor control portion 4.

Numeral 3 denotes an optical pickup device, which projects a light beam emitted by a light source to the optical recording medium 12 so as to enable writing of information on the optical recording medium 12 and reading of information recorded on the optical recording medium 12. FIG. 2 is a schematic diagram to show an optical system of an optical pickup device 3. As shown in FIG. 2, in the optical pickup device 3, light beams emitted from the light sources 13 and 14 are made to have the same optical axis by a color composition prism 15. Then, the light beams are made parallel rays by a collimator lens 16, pass through a beam splitter 17, and are reflected by an upstand mirror 18 so that an optical axis thereof is made to be substantially perpendicular to a recording surface 12a of the optical recording medium 12. Then, the light beams pass through a liquid crystal element 19 and are condensed by an objective lens 20 on the recording surface 12a of the optical recording medium on which information is recorded.

Reflection light reflected by the optical recording medium 12 passes through the objective lens 20 and the liquid crystal element 19 in this order and is reflected by the upstand mirror 18. Then the reflection light is further reflected by the beam splitter 17 and is condensed by a condenser lens 21 on a light reception portion (not shown) of a photo detector 22. At this point the light source 13 in the present embodiment is a two-wavelength combination laser diode that emits light beams for a CD and for a DVD, while the light source 14 is a laser diode that emits a light beam for a BD. By this arrangement, the optical disc apparatus 1 can read and write a CD, a DVD, and a BD.

The optical pickup device 3 can support three different types of optical recording media 12. As described above, these different types of optical recording media 12 have different thickness of the protection layer. Accordingly, as to the optical pickup device 3 having a single objective lens 20 like the present embodiment, the spherical aberration becomes a problem. Therefore, the liquid crystal element 19 is disposed for correcting the spherical aberration.

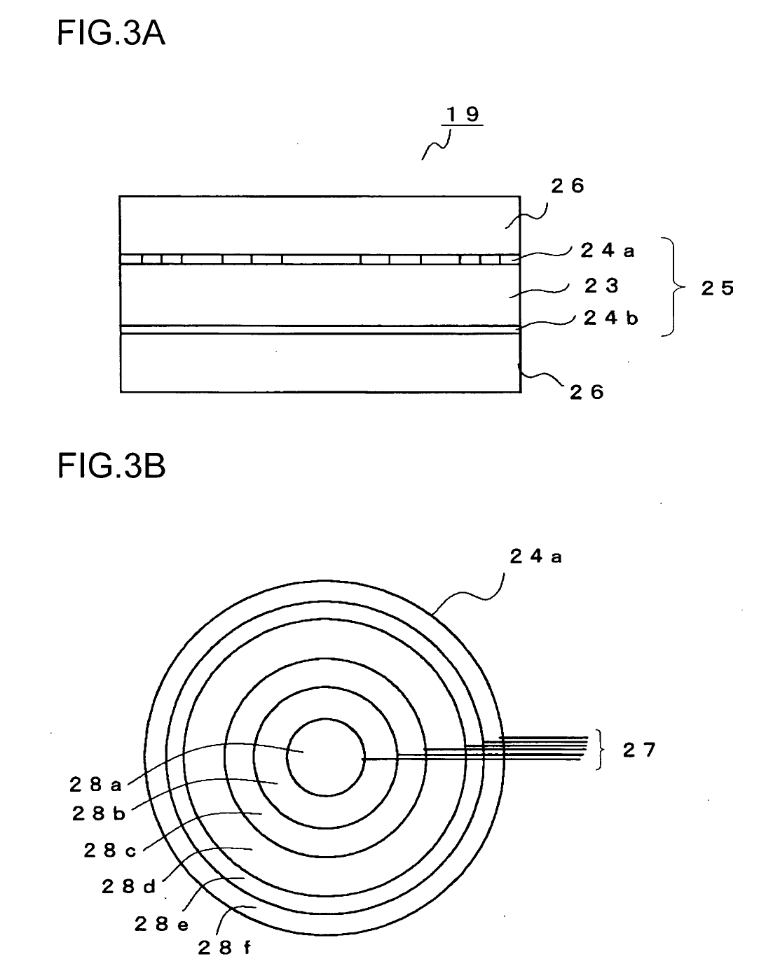

FIGS. 3A and 3B are explanatory diagrams for explaining a structure of the liquid crystal element 19 included in the optical pickup device. FIG. 3A is a schematic cross sectional view to show a structure of the liquid crystal element 19, and FIG. 3B is a plan view viewed from the top surface of the liquid crystal element 19 shown in FIG. 3A. As shown in FIGS. 3A and 3B, the liquid crystal element 19 is made up of liquid crystal 23, two transparent electrodes 24a and 24b sandwiching the liquid crystal 23, two glass plates 26 sandwiching a portion 25 consisting of the liquid crystal 23 and the transparent electrodes 24a and 24b.

As shown in FIG. 3B, the transparent electrode 24a of the liquid crystal element 19 is divided into a plurality of concentric areas 28a-28f. On the other hand, the transparent electrode 24b that is opposed to the transparent electrode 24a is a single common electrode as a whole without being divided. At this point it is possible that the transparent electrode 24b also has a plurality of concentric areas in the same manner as the transparent electrode 24a. When the transparent electrodes 24a and 24b are structured in this manner, it is possible to generate a desired phase difference in the light beam that passes through the liquid crystal element 19. Thus, the spherical aberration that is generated when information is read or written on various types of the optical recording media 12 can be corrected appropriately. At this point the transparent electrodes 24a and 24b are electrically connected by wires 27 to a liquid crystal element control portion that will be described later, and this liquid crystal element control portion controls voltages to be applied to the transparent electrodes 24a and 24b.

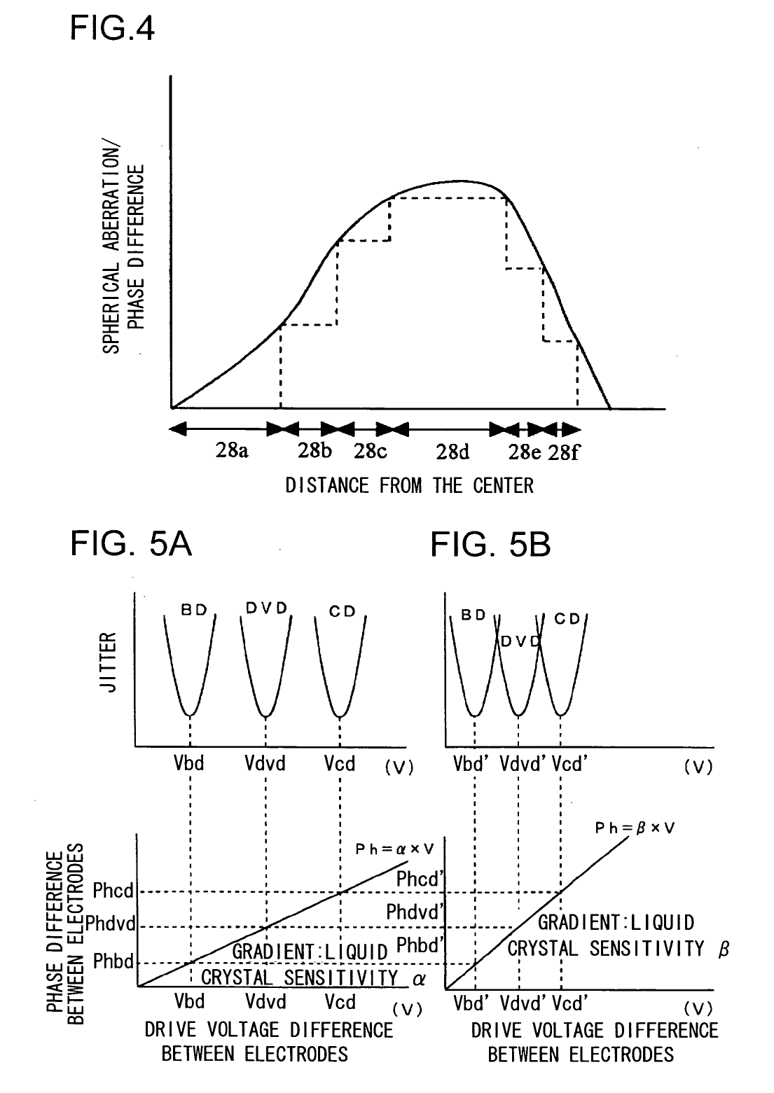

Actions of the liquid crystal element 19 having the structure as described above will be described. FIG. 4 is a graph to show the spherical aberration that is generated when a certain optical recording medium 12 is read or written (shown by a solid line in FIG. 4) and a phase difference to be generated by the liquid crystal element 19 for correcting the spherical aberration (shown by a broken line in FIG. 4). Furthermore, the phase difference pattern to be generated by the liquid crystal element 19 is required to be a pattern having an opposite phase to the phase difference shown in FIG. 4 in order to cancel the spherical aberration. However, it is not shown as a pattern having an opposite phase in FIG. 4 for the sake of convenience. Further in FIG. 4, the horizontal axis shows a distance from the center of the transparent electrode 24a that is divided in a concentric manner, and numerals under the horizontal axis correspond to area numbers on the transparent electrode 24a (see FIG. 3B).

When a voltage is applied to the transparent electrodes 24a and 24b so that a phase difference pattern opposite to the phase difference pattern shown in FIG. 4 (by the broken line) in each of the areas 28a-28f, the aberration is corrected to be reduced to a level at which there is no problem for reading and writing the optical recording medium 12. Thus, an appropriate reproduced signal is obtained. At this point quantity of the generated spherical aberration depends on the type of the optical recording medium 12. Therefore, the phase difference to be generated by the liquid crystal element 19 should be different in accordance with the type of the optical recording medium 12, and values of the voltages to be applied to the transparent electrodes 24a and 24b are also different.

With reference to FIG. 1 again, the optical disc apparatus 1 is equipped with a laser control portion 5, a servo control portion 6, a record control portion 7, a reproduction control portion 8, and a liquid crystal element control portion 9. At this point these control portions 5-9 and the spindle motor control portion 4 described above are connected to a system control portion 10 for controlling the entire system. Each of the control portions 5-9 will be described below.

The laser control portion 5 controls output power of a laser emitted from semiconductor lasers that are the light sources 13 and 14 (see FIG. 2) of the optical pickup device 3. In addition, the laser control portion 5 is connected to the record control portion 7, and a drive control of the laser control portion 5 is performed by a signal from the record control portion 7. The record control portion 7 will be described later.

The servo control portion 6 performs a servo control such as a focusing control and a tracking control of the optical pickup device 3. The servo control portion 6 generates a focus error signal and a tracking error signal in accordance with an electric signal light obtained by the photo detector 22 (see FIG. 2), and the servo control portion 6 supplies a drive signal to an actuator (not shown) on which the liquid crystal element 19 and the objective lens 20 (see FIG. 2) that are provided to the optical pickup device 3, are equipped with. The actuator which is supplied with the drive signal, activates each portion in accordance with the signal so as to perform the focusing control in which the objective lens 20 is moved in the direction that is parallel with the optical axis for adjusting focus and the tracking control in which the objective lens 20 is moved in the radial direction of the optical recording medium 12 for adjusting a position of the light beam spot to a position of a track formed on the optical recording medium 12.

The record control portion 7 modulates the information data that are entered from an external apparatus (not shown) such as a personal computer via an interface 11 by a modulation circuit (not shown). The modulated data signal is sent to the laser control portion 5.

The reproduction control portion 8 generates a reproduced signal by using the electric signal detected by the photo detector 22 that is provided to the optical pickup device 3. Then, the generated reproduced signal is transmitted to an external device such as a personal computer via the interface 11.

The liquid crystal element control portion 9 controls application voltages that are applied to the transparent electrodes 24a and 24b of the liquid crystal element 19 that are provided to the optical pickup device 3. As described above, the spherical aberration is different among various types of the optical recording media 12. Therefore, the data of voltages to be applied to the transparent electrodes 24a and 24b for various types of the optical recording media 12 (a CD, a DVD, and a BD) are stored in a storage portion (not shown) that is provided to the liquid crystal element control portion 9. The data of voltages to be applied that are stored in the storage portion are adjustment voltage values in which characteristic variation of the liquid crystal among devices is adjusted, considering that there is variation in characteristic of the liquid crystal 23 of the liquid crystal element 19. An adjusting method of the optical disc apparatus for obtaining the adjustment voltage value and for storing the same in the storage portion will be described later.

Although the adjustment voltage value is stored in the storage portion that is provided to the liquid crystal element control portion 9 in the present embodiment, the storage portion for storing the adjustment voltage value can be provided to the system control portion 10 or the like, for example, without being limited to the liquid crystal element control portion 9.

Hereinafter, an adjusting method of the optical disc apparatus for adjusting characteristic variation in liquid crystal among optical pick up devices of the optical disc apparatus 1 according to the present invention, will be described with reference to one example of the embodiment. Before the description, a concept of the adjustment of characteristic variation of the liquid crystal among devices according to the present invention will be described. As to the optical disc apparatus that can read and write a plurality of types of optical recording media 12 like the optical disc apparatus 1 of the present embodiment, it is necessary to determine the drive voltage of the liquid crystal element 19 (see FIGS. 2, 3A, and 3B) in the case where an optical reproduced signal is obtained for each of the various types of the optical recording medium 12 in order to adjust characteristic variation in liquid crystal among the optical pick up devices for each optical disc apparatus 1. In this case, if measurement is performed for each optical recording medium for the adjustment, it takes a long time for the measurement so that the adjustment work requires a lot of time. The present invention is aimed at shortening the time necessary for this adjustment work.

FIGS. 5A and 5B are explanatory diagrams for explaining the concept of adjusting characteristic variation of the liquid crystal among devices according to the present invention. FIG. 5A is a graph concerning an optical disc apparatus equipped with a liquid crystal element 19 that is manufactured by using liquid crystal having characteristic to be a reference (hereinafter referred to as a reference optical disc apparatus), and FIG. 5B is a graph concerning an optical disc apparatus to be adjusted in the adjustment of characteristic variation of liquid crystal. At this point the reference optical disc apparatus and the optical disc apparatus 1 to be adjusted have the same structure except for characteristic of the liquid crystal element.

In FIGS. 5A and 5B, a drive voltage difference between electrodes is a value obtained by subtracting a minimum voltage value from a maximum voltage value among voltages that are applied to the areas 28a-28f (see FIG. 3B) of the transparent electrodes 24a and 24b (see FIG. 3A, B) of the liquid crystal element 19 (corresponding to a difference between voltage values that are applied to the areas 28d and 28a in FIG. 3B). In addition, a phase difference between electrodes is a value obtained by subtracting a minimum phase difference from a maximum phase difference among phase differences that are generated in the case where voltages are applied to the areas (corresponding to a difference between phase differences generated in the areas 28d and 28a in FIG. 3B). Furthermore, liquid crystal sensitivity is a ratio between a variation of a voltage that is applied to the liquid crystal element 19 and a variation of the phase difference, and it is also an index of characteristic of liquid crystal. In FIGS. 5A and 5B, it corresponds to a ratio of the drive voltage difference between electrodes to the phase difference between electrodes (i.e., a gradient of a straight line of the graph).

Supposing that a represents the liquid crystal sensitivity of liquid crystal of the reference optical disc apparatus and β represents the liquid crystal sensitivity of the liquid crystal of the optical disc apparatus to be adjusted, a does not equal to β usually because there is characteristic variation in liquid crystal. In this case, the drive voltage difference between electrodes in which an optimal reproduced signal is obtained in the optical disc apparatus (a jitter value is used as its index in FIGS. 5A and 5B) is different between the reference optical disc apparatus and the optical disc apparatus to be adjusted in each case of a CD, a DVD, and a BD. This is expressed as Vcd≠Vcd′, Vdvd≠Vdvd′, and Vbd≠Vbd′ using symbols as shown in FIG. 5. On the other hand, in various types of the optical recording media 12, the phase difference between electrodes in the case where an optimal reproduced signal is obtained is constant without any relationship with the characteristic variation of the liquid crystal. This is expressed as Phcd=Phcd′, Phdvd=Phdvd′, and Phbd=Phbd′ using symbols as shown in FIG. 5.

Therefore, if the drive voltage difference between electrodes in the case where an optimal reproduced signal is obtained is determined for one of the optical recording media 12 including a CD, a DVD, and a BD, the liquid crystal sensitivity β can be calculated from a ratio of it to the phase difference between electrodes that was determined for the reference optical disc apparatus. Then, if the liquid crystal sensitivity β is determined, the drive voltage difference between electrodes can be calculated also for the optical recording medium 12 that was not measured, by using the phase difference between electrodes that was determined for the reference optical disc apparatus and the liquid crystal sensitivity β. In other words, according to the concept described above, if it is performed to obtain data about the liquid crystal element 19 in the case where an optimal reproduced signal is obtained for each of the optical recording media 12 that can be read and written by the optical disc apparatus 1 when the reference data is created, it is sufficient after that only to obtain data about the drive voltage of the liquid crystal element 19 in the case where an optimal reproduced signal is obtained only for one type of the optical recording medium. Therefore, a period of time necessary for the measurement can be shortened substantially, and the optical disc apparatus 1 having liquid crystal with adjusted characteristic variation can be provided easily.

In the above description, the drive voltage difference between electrodes is defined as a value obtained by subtracting a minimum voltage value from a maximum voltage value among voltage values to be applied to the areas 28a-28f because it is easy to obtain a correct value when actual measurement is performed. However, concerning this point, it is possible to define it as a value obtained by subtracting a smaller voltage value from a larger voltage value that are applied to two areas selected from the areas 28a-28f as areas to which different voltage values are applied, for example. In addition, it is also possible to define the phase difference between electrodes as a value obtained by subtracting a smaller phase difference value from a larger phase difference value that are generated in the two areas mentioned above, for example.

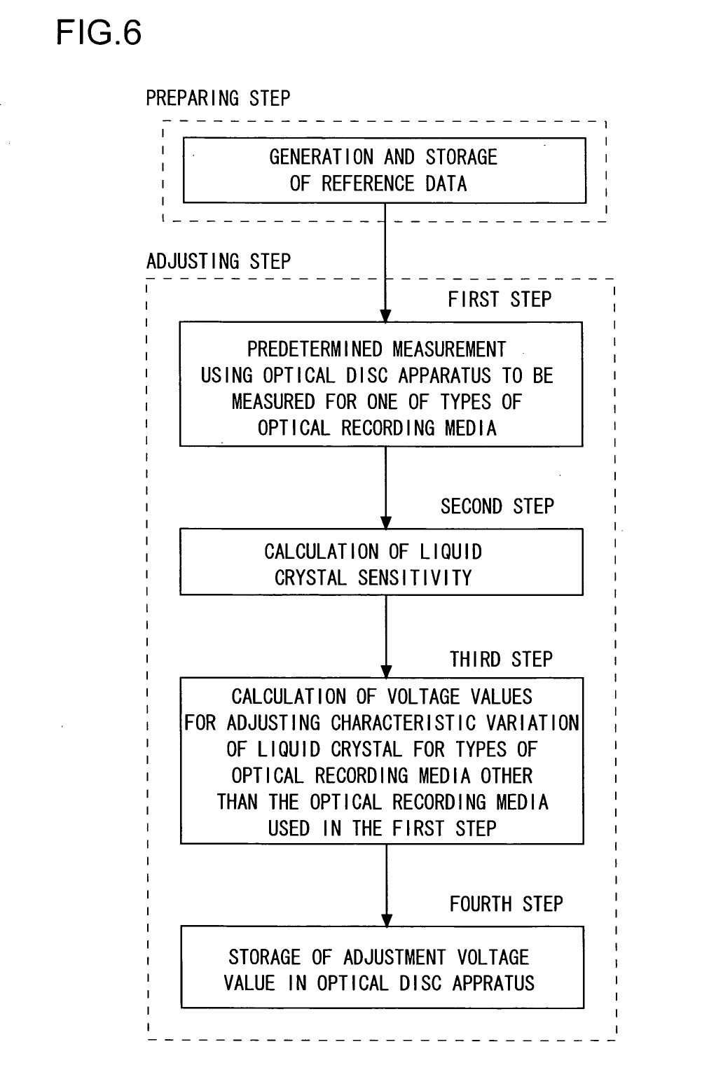

Hereinafter, an embodiment of the method for adjusting the characteristic variation of the liquid crystal among optical disc apparatus according to the present invention will be described with reference to an example. In the description below, the terms “drive voltage difference between electrodes”, “phase difference between electrodes”, and “liquid crystal sensitivity” are used in the same meaning as the case shown in FIGS. 5A and 5B. FIG. 6 is a diagram to show a procedure of adjusting method of the optical disc apparatus for adjusting characteristic variation of liquid crystal. As shown in FIG. 6, the method for adjusting characteristic variation in liquid crystal among optical pick up devices for the optical disc apparatus according to the present invention includes two steps, i.e., a preparing step that is a preparing stage for the adjustment work and an adjusting step for performing a real adjustment.

First, a preparing step will be described. Generation of the reference data is performed by using the reference optical disc apparatus described above. Although a completed product of the optical disc apparatus is used for generating the reference data in the present embodiment, the present invention is not always limited to this structure. It is possible to use uncompleted optical disc apparatus as long as it includes the optical pickup having the same optical system as the optical pickup of the optical disc apparatus 1 to be measured. In addition, there is not a limitation to characteristic of the liquid crystal used for the reference optical disc apparatus when the reference optical disc apparatus is selected. However, it is preferable to adopt an optical disc apparatus that uses liquid crystal having average characteristic among liquid crystal that is used in the optical disc apparatus 1.

This reference optical disc apparatus is used for obtaining voltage values to be applied to the areas 28a-28f of the transparent electrodes 24a and 24b in the case where an optimal jitter value is obtained (i.e., the reference voltage values) and phase differences generated in the areas 28a-28f when the voltage values are applied (i.e., the reference phase differences) by measurement for each of a CD, a DVD, and a BD. From the obtained reference voltage value and the reference phase difference, the drive voltage difference between electrodes and the phase difference between electrodes are calculated. Then, the reference voltage values, the drive voltage differences between electrodes (Vcd, Vdvd, and Vbd) and the phase differences between electrodes (Phcd, Phdvd, and Phbd) are stored as the reference data for each of various types of the optical recording media 12 in an external device such as a personal computer, the storage portion of the optical disc apparatus 1, or the like. The reference data is generated in the reference data generation step only once, and it is not necessary to generate the data again.

Although the reference data are obtained in the case where an optimal jitter value is obtained in the present embodiment, the present invention is not limited to this structure. It is sufficient to obtain the reference data in the case where an optimal reproduced signal is obtained. For example, it is possible to obtain the reference data in the case where an optimal RF signal or an optimal TE signal is obtained.

In addition, although the data that are stored as the reference data are the reference voltage values, the drive voltage differences between electrodes and the phase differences between electrodes for various types of the optical recording media 12 in the present embodiment, the present invention is not limited to this structure. Contents of the data can be modified within the scope of the present invention. For example, it is possible to store the reference phase difference too as the reference data and to store other additional data. In the case where the reference voltage value and the reference phase difference are stored as the reference data, the drive voltage difference between electrodes and the phase difference between electrodes can be calculated, if necessary. Therefore, it is possible that the drive voltage difference between electrodes and the phase difference between electrodes are not stored as the reference data.

Next, the adjusting step will be described. The adjusting step includes four steps, i.e., a first to a fourth steps as shown in FIG. 6. Each of the steps will be described in detail one by one below.

In the first step, measurement of a jitter value is performed for one of a CD, a DVD, and a BD by using the optical disc apparatus 1 to be measured. Then, the first voltage values to be applied to the areas 28a-28f in the case where an optimal jitter value is obtained are determined. In the present embodiment, this measurement of a jitter value is performed for a DVD.

At this point there is no limitation about which type of optical recording medium 12 is selected. However, as the selected type of the optical recording medium 12, it is necessary to use the optical recording medium that has known characteristic so as to avoid a generation of aberration due to a factor other than the characteristic variation of liquid crystal, such as aberration generated due to variation of thickness or the protection film or the like, which may cause insufficient adjustment of characteristic variation of liquid crystal. Therefore, it is preferable to use an optical recording medium that is the same or has the same characteristic as the one used for generating the reference data. In the present embodiment, an optical recording medium that is the same or has the same characteristic as the one used for generating the reference data is used. Furthermore, although the measurement of a jitter value is performed in the present embodiment, it is possible to perform a measurement of the RF signal or the TE signal in the same manner as the case of generating the reference data.

In the second step, the first voltage values that were obtained in the first step are used for determining the drive voltage difference between electrodes (Vdvd′). Then, the liquid crystal sensitivity β is calculated from the drive voltage difference between electrodes and the phase difference between electrodes (Phdvd) for a DVD stored as the reference data by using the following equation.

β=Phdvd/Vdvd′

In third step, the drive voltage differences between electrodes (Vcd′ and Vbd′) for a CD and for a BD that are not measured in the case where an optimal jitter value is obtained are determined from the liquid crystal sensitivity β obtained in the second step and the phase differences between electrodes (Phcd and Phbd) for a CD and for a BD stored as the reference data by using the following equation.

Vcd′=Phcd/PVbd′=Phbd/p

Then, the second voltage values in which the characteristic variation of liquid crystal is adjusted are determined from the obtained drive voltage difference between electrodes (Vcd′ and Vbd′) and the voltage values of the areas 28a-28f for a CD and a BD stored as the reference data (i.e., the reference voltage values).

In the fourth step, the first voltage value of the measured DVD in which the characteristic variation of liquid crystal is adjusted that was obtained in the first step and the second voltage values for a CD and for a BD that were obtained by the calculation in the third step are stored as the adjustment voltage value in the storage portion or the like provided to the liquid crystal control portion 9 (see FIG. 1) of the optical disc apparatus 1, for example. Thus, the optical disc apparatus 1 can suppress a generation of aberration due to the characteristic variation of liquid crystal.

It should be noted that that the calculation method of the second voltage values is not limited to the method of the present embodiment. For example, it is possible to determine a liquid crystal sensitivity a of liquid crystal provided to the reference optical disc apparatus and to store the same as the reference data, so that the second voltage values are determined from the liquid crystal sensitivity β obtained for the optical disc apparatus 1 to be adjusted and the liquid crystal sensitivity a and the voltage values of the areas 28a-28f (i.e., the reference voltage values) stored as the reference data.

Furthermore, although the optical disc apparatus 1 can read and write a CD, a DVD, and a BD in the embodiment described above, the present invention is not limited to this structure. The structure can be modified variously within the scope of the present invention. For example, it is possible that the optical disc apparatus 1 can read and write an HD-DVD adding to these three types of the optical recording media. The adjusting method of the optical disc apparatus according to the present invention can be applied to this case too. Furthermore, although the optical disc apparatus of the present invention can perform both reading and writing, it is possible that the optical disc apparatus can perform only reading. The adjusting method of the optical disc apparatus according to the present invention can be applied to this case too.

Further, although the liquid crystal element 19 is disposed for correcting the spherical aberration in the optical disc apparatus 1 according to the present embodiment, the present invention is not limited to this structure. For example, the present invention can also be applied to a structure in which the liquid crystal element is disposed for a purpose of correcting wave aberration other than the spherical aberration.

According to the adjusting method of the optical disc apparatus for adjusting characteristic variation of the liquid crystal among devices according to the present invention, characteristic variation of the liquid crystal can be adjusted in a short period of time. Therefore, it is possible to provide optical disc apparatus in which characteristic variation of liquid crystal is adjusted though it is not adjusted in the conventional devices. Then, an improvement in reproduction performance can be expected because generation of undesired aberration can be suppressed by the optical disc apparatus in which characteristic variation of liquid crystal is adjusted.

What is claimed is:

1. An adjusting method of an optical disc apparatus for adjusting characteristic variation in liquid crystal among optical pick up devices for the optical disc apparatus that can perform reading and writing or perform only reading of a plurality of types of optical recording media and is equipped with a liquid crystal element disposed in the optical system of the optical pickup, the liquid crystal element including liquid crystal and two transparent electrodes sandwiching the liquid crystal, the method comprising:
a preparing step for performing a measurement by using an optical pickup having the same optical system as the optical pickup of the optical disc apparatus to be adjusted so as to obtain a reference voltage value that is a voltage value to be applied to the transparent electrode in the case where an optimal reproduced signal is obtained for each of the plurality of types of optical recording media and a reference phase difference that is a phase difference generated in the liquid crystal element when the reference voltage value is applied, and for creating and storing predetermined data concerning the reference voltage value and the reference phase difference as reference data; and
an adjusting step for obtaining an adjustment voltage value for adjusting characteristic variation of the liquid crystal for all the plurality of types of optical recording media by selecting one type of optical recording medium among the plurality of types of optical recording media as an adjustment optical recording medium, by obtaining a first voltage value that is applied to the transparent electrode in the case where the optimal reproduced signal is obtained for the optical disc apparatus to be adjusted by using a predetermined optical recording medium for the adjustment optical recording medium, and by calculating a second voltage value to be applied to the transparent electrode in which characteristic variation of the liquid crystal is adjusted from the reference data and the first voltage value for each of the plurality of types of optical recording media except the adjustment optical recording medium.

2. The adjusting method of an optical disc apparatus according to claim 1, wherein at least one of the transparent electrodes is divided into a plurality of concentric areas, and the adjusting step includes
a first step for obtaining the first voltage value to be applied to each of the areas for the optical disc apparatus to be adjusted by using the predetermined optical recording medium,
a second step for calculating characteristic of the liquid crystal that is determined as a ratio of a difference between the first voltage values in two predetermined areas to a difference between reference phase differences in the two predetermined areas among the first voltage values of the areas obtained in the first step,
a third step for calculating the second voltage value for each of the plurality of types of optical recording media except the adjustment optical recording medium by using the characteristic of the liquid crystal obtained in the second step and the reference data, and
a fourth step for storing the first and the second voltage values obtained in the first and the third steps as the adjustment voltage value in a storage portion provided to the inside of the optical disc apparatus to be adjusted.

3. The adjusting method of an optical disc apparatus according to claim 2, wherein the two predetermined areas includes an area in which the first voltage value becomes a maximum value and an area in which the first voltage value becomes a minimum value.

4. An adjusting method of an optical disc apparatus for adjusting characteristic variation in liquid crystal among optical pick up devices for the optical disc apparatus that can perform reading and writing or perform only reading of a plurality of types of optical recording media and is equipped with a liquid crystal element disposed in the optical system of an optical pickup, the liquid crystal element including liquid crystal and two transparent electrodes sandwiching the liquid crystal, at least one of the transparent electrodes being divided into a plurality of concentric areas, the method comprising:
a preparing step for performing a measurement by using an optical pickup having the same optical system as the optical pickup of the optical disc apparatus to be adjusted so as to obtain a reference voltage value that is a voltage value to be applied to each of the areas of the transparent electrode in the case where an optimal reproduced signal is obtained for each of the plurality of types of optical recording media and a reference phase difference that is a phase difference generated in each of the areas when the reference voltage value is applied, and for creating and storing predetermined data concerning the reference voltage value and the reference phase difference as reference data; and
an adjusting step including a first step for selecting one type of optical recording medium among the plurality of types of optical recording media as an adjustment optical recording medium, and for obtaining a first voltage value to be applied to each of the areas in the case where an optimal reproduced signal is obtained for the optical disc apparatus to be adjusted by using the predetermined optical recording medium for the adjustment optical recording medium, a second step for calculating characteristic of the liquid crystal that is determined as a ratio of a difference between a maximum value and a minimum value of the first voltage value to a difference between the reference phase differences in the area where the first voltage becomes a maximum value and the area where the first voltage becomes a minimum value, a third step for calculating a second voltage value to be applied to the transparent electrode in which characteristic variation of the liquid crystal is adjusted for each of the plurality of types of optical recording media except the adjustment optical recording medium by using characteristic of the liquid crystal obtained in the second step and the reference data, and a fourth step for storing the first and the second voltage values obtained in the first and the third steps as the adjustment voltage value for adjusting characteristic variation of the liquid crystal in a storage portion provided to the inside of the optical disc apparatus to be adjusted.

5. An optical disc apparatus that is adjusted by the adjusting method of an optical disc apparatus according to claim 1.
